(19) United States
(12) Patent Application Publication
(10) Pub. No.: US 2020/0307617 A1
(43) Pub. Date: Oct. 1, 2020

(54) VEHICLE DRIVING ASSISTANCE SYSTEM, VEHICLE DRIVING ASSISTANCE METHOD, AND VEHICLE DRIVING ASSISTANCE PROGRAM

(71) Applicant: AISIN AW CO., LTD., Anjo-shi, Aichi-ken (JP)

(72) Inventors: Takamitsu SAKAI, Nukata (JP); Ryosuke TOBUCHI, Okazaki (JP)

(73) Assignee: AISIN AW CO., LTD., Anjo-shi, Aichi-ken (JP)

(21) Appl. No.: 16/649,524

(22) PCT Filed: Nov. 14, 2018
(86) PCT No.: PCT/JP2018/042079

§ 371 Date: Mar. 20, 2020

(30) Foreign Application Priority Data
Nov. 17, 2017 (JP) 2017-222161

(51) Int. Cl. B60W 50/14; B60W 30/095

(52) U.S. Cl. CPC B60W 50/14; B60W 30/0956; B60W 2050/146; B60W 2554/4049; B60W 2554/4042; B60W 2554/4041; B60W 2554/4044

(57) ABSTRACT

Vehicle driving assistance systems, methods, and programs display an alert image superimposed on a real view on a display. The alert image is an image having a region indicating a call for attention based on a course of a dynamic obstacle, the dynamic obstacle being one or a plurality of moving obstacles. The region indicating the call for attention varies depending on a likelihood of the course of the dynamic obstacle changing due to presence of another obstacle.

### TECHNICAL FIELD

Technical fields include vehicle driving assistance techniques for assisting in driving of a vehicle by a driver.

### BACKGROUND

JP 2005-56372 A discloses a vehicle control device that calculates a travel route for allowing a vehicle to travel while avoiding obstacles present around the vehicle (claim 1, FIG. 33, etc.). The travel route is set so as to avoid dangerous regions set on a map. The dangerous regions are set based on the locations, moving directions, and moving speeds of objects such as vehicles, bicycles, and pedestrians. For example, by referring to the dangerous regions or a travel route set so as to avoid the dangerous regions, a driver can perform a driving operation considering other vehicles, bicycles, pedestrians, etc.

### SUMMARY

The vehicle control device sets dangerous regions without taking into account a mutual relationship between objects such as vehicles, bicycles, and pedestrians. However, in practice, an object's moving direction and moving speed may change depending on the relationship with another object, e.g., a bicycle passes a pedestrian or a vehicle passes a bicycle. Hence, setting dangerous regions simply based on the locations, moving directions, and moving speeds of individual objects leaves a room for improvement in terms of informing about information for avoiding obstacles such as other vehicles, bicycles, and pedestrians present around a vehicle.

In view of the above-described background, exemplary embodiments of the broad inventive principles described herein appropriately inform a driver about information for traveling while avoiding moving obstacles, taking also into account a correlation between a plurality of obstacles around a vehicle.

Exemplary embodiments provide vehicle driving assistance systems, methods, and programs that display an alert image superimposed on a real view on a display. The alert image is an image having a region indicating a call for attention based on a course of a dynamic obstacle, the dynamic obstacle being one or a plurality of moving obstacles. The region indicating the call for attention varies depending on a likelihood of the course of the dynamic obstacle changing due to presence of another obstacle.

Technical features of such a vehicle driving assistance system are also applicable to a vehicle driving assistance method and a vehicle driving assistance program. For example, the vehicle driving assistance method can have various steps including features of the above-described vehicle driving assistance system. In addition, the vehicle driving assistance program can cause a computer to implement various functions including the features of the above-described vehicle driving assistance system. As a matter of course, these vehicle driving assistance method and vehicle driving assistance program can also provide the functions and effects of the above-described vehicle driving assistance system.

According to these characteristic configurations, by displaying an alert image, a driver can be appropriately informed about the presence of a dynamic obstacle. In addition, by displaying the alert image in a different region based on whether a course of the dynamic obstacle changes due to another obstacle, the driver can be informed that the course of the dynamic obstacle is likely to change. By this, the driver can perform a driving operation, paying more attention to the dynamic obstacle. As such, according to these characteristic configurations, taking also into account a correlation between a plurality of obstacles around a vehicle, the driver can be appropriately informed about information for traveling while avoiding moving obstacles.

Further features and advantages of the vehicle driving assistance system, the vehicle driving assistance method, and the vehicle driving assistance program will become apparent from the following description of embodiments which are described with reference to drawings.

### BRIEF DESCRIPTION OF THE DRAWINGS

FIG. 1 is a perspective view showing an example of an area near a driver's seat of a vehicle.

FIG. 2 is a block diagram schematically showing an example of a system configuration of a vehicle driving assistance system.

FIG. 3 is a plan view showing a concept of driving assistance.

FIG. 4 is a plan view showing a concept of driving assistance.

FIG. 5 is a plan view showing a concept of driving assistance.

FIG. 6 is a flowchart showing an example of a procedure of driving assistance.

FIG. 7 is a flowchart showing an example of a procedure for determining a region in which an alert image is displayed.

FIG. 8 is a diagram showing an example of an alert image superimposed on a real view.

FIG. 9 is a diagram showing an example of an alert image superimposed on a real view.

FIG. 10 is a diagram showing an example of an alert image superimposed on a real view.

FIG. 11 is a plan view showing a concept of driving assistance.

FIG. 12 is a plan view showing a concept of driving assistance.

FIG. 13 is a diagram showing an example of a condition for setting a recommended route.

FIG. 14 is a diagram showing an example of alert images superimposed on a real view.

### DETAILED DESCRIPTION OF EXEMPLARY EMBODIMENTS

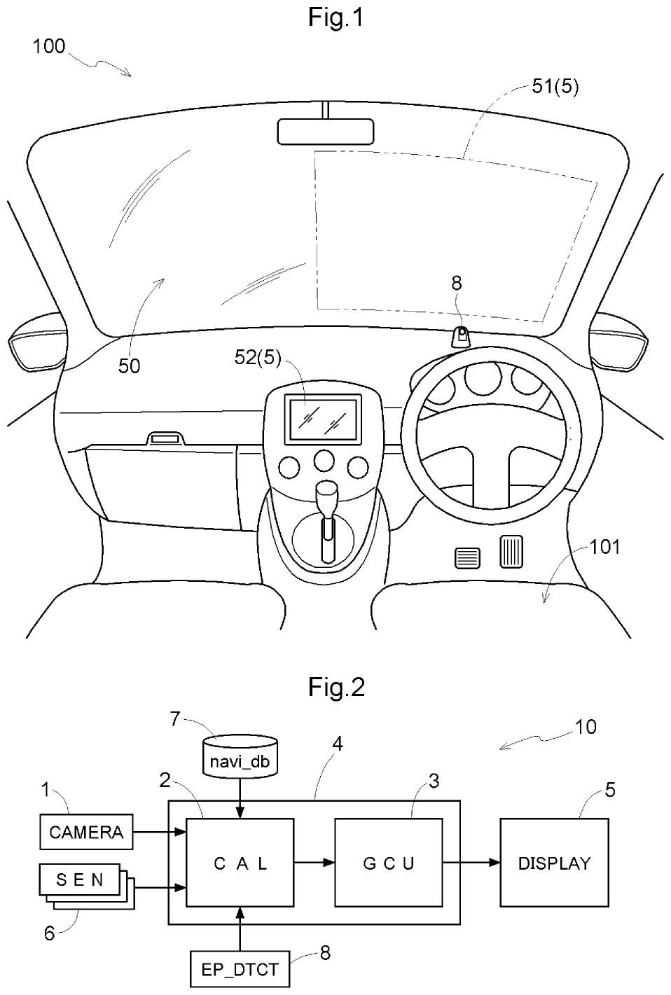

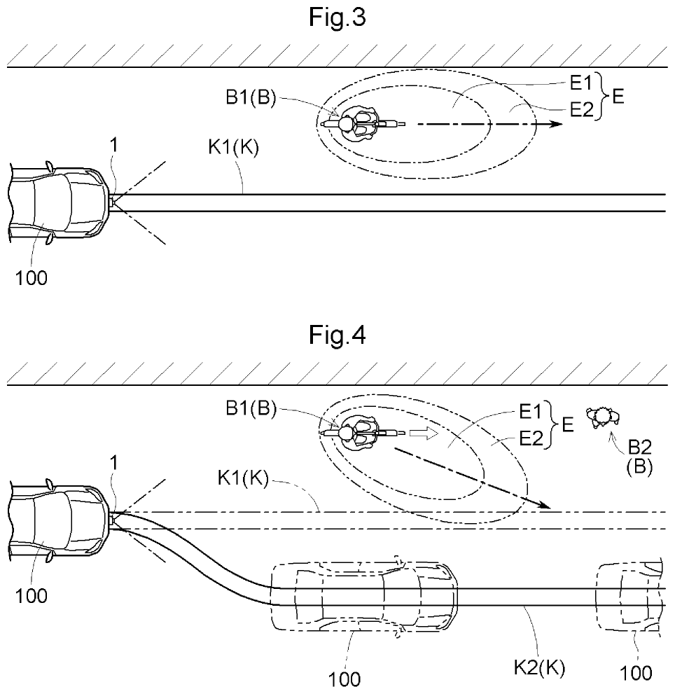

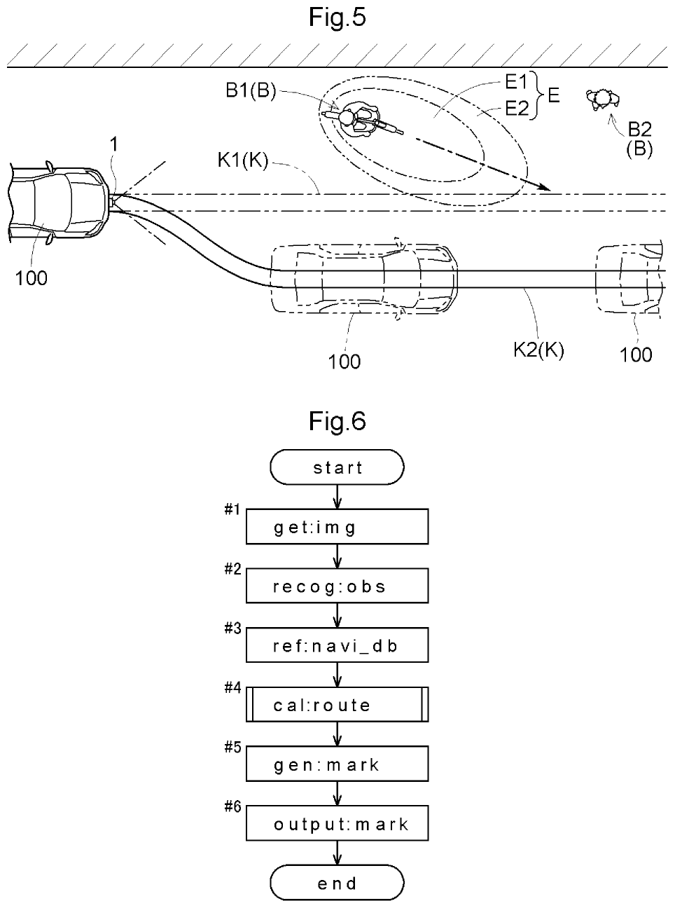

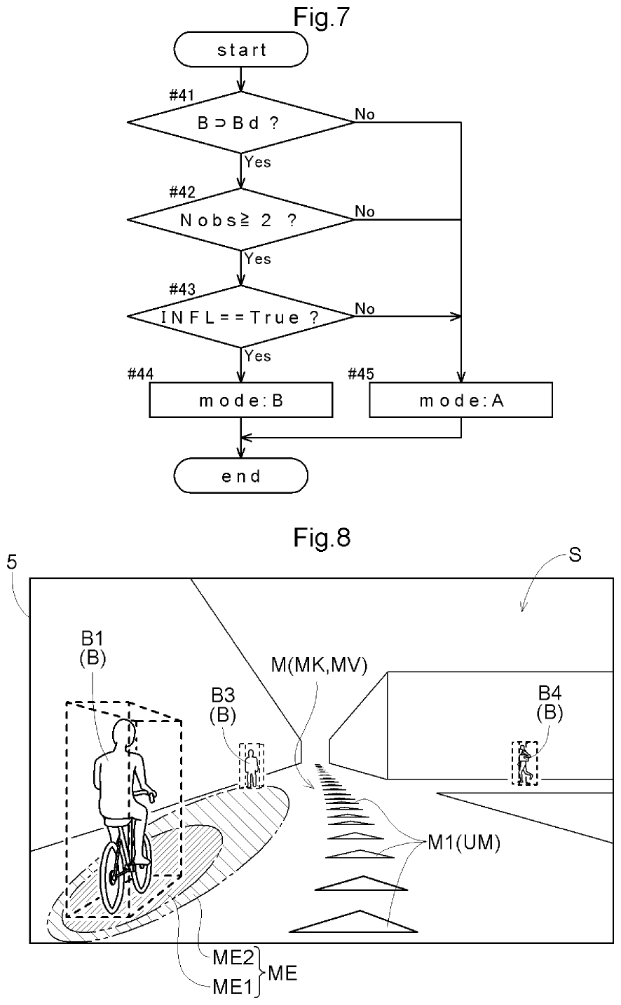

An embodiment of a vehicle driving assistance system (including a vehicle driving assistance method and a vehicle driving assistance program) will be described below based on the drawings. FIG. 1 shows an example of an area near a driver's seat 101 of a vehicle 100 having a vehicle driving assistance system mounted thereon, and a block diagram of FIG. 2 schematically shows an example of a system configuration of a vehicle driving assistance system 10. FIGS. 3 to 5 show a concept of driving assistance provided by the vehicle driving assistance system 10, and flowcharts of FIGS. 6 and 7 show an example of a procedure of driving assistance which is implemented as, for example, a vehicle driving assistance method and a vehicle driving assistance program. In addition, FIGS. 8 to 10 show an example of an alert image ME superimposed on a real view S. (As used herein, the term “storage medium” does not include transitory signals).

The vehicle driving assistance system 10 is a system that provides a driver with information for assisting in driving. In the present embodiment, the vehicle driving assistance system 10 provides the driver with information for assisting in driving by displaying an alert image ME superimposed on a real view S (see FIGS. 8 to 10, etc.). Note that although the present embodiment exemplifies a mode in which a recommended driving image M is further superimposed and displayed, it is sufficient to superimpose only an alert image ME without superimposing the recommended driving image M.

Note that the vehicle driving assistance method is a method for providing driving assistance by using, for example, hardware and software that form the vehicle driving assistance system 10 such as those which will be described later with reference to FIG. 2, etc. Note also that the vehicle driving assistance program is a program that is executed on, for example, a computer (e.g., an arithmetic processing unit 4 which will be described later with reference to FIG. 2) included in the vehicle driving assistance system 10, to implement a vehicle driving assistance function.

A real view S on which an alert image ME and a recommended driving image M are superimposed may be a view seen from the driver's seat 101 through a windshield 50 of the vehicle 100, or may be video that is shot by a front camera 1 (see FIGS. 2 and 3, etc.) which will be described later, and shown on a monitor 52. When the real view S is a view seen through the windshield 50, the alert image ME and the recommended driving image M are, for example, rendered on a head-up display 51 which is formed on the windshield 50, and superimposed on the real view S. A dashed-line region shown in the windshield 50 in FIG. 1 is a region in which the head-up display 51 is formed. In addition, when the real view S is video shown on the monitor 52, the alert image ME and the recommended driving image M are superimposed on the video.

As shown in FIG. 2, the vehicle driving assistance system 10 includes the front camera 1 (CAMERA), an arithmetic processing device 2 (CAL), a graphic control unit 3 (GCU), and a display device 5 (DISPLAY). In the present embodiment, the arithmetic processing device 2 and the graphic control unit 3 are formed as a single processor (a system LSI, a digital signal processor (DSP), etc.) or as a part of the arithmetic processing unit 4 which is formed as a single electronic control unit (ECU). As a matter of course, the arithmetic processing unit 4 may include other functional parts which are not shown. In addition, the display device 5 (display part) includes the above-described head-up display 51 and monitor 52.

In the present embodiment, the vehicle driving assistance system 10 further includes a sensor group 6 (SEN), a navigation database 7 (navi_db), and an eyepoint detection device 8 (EP_DTCT). The sensor group 6 can include sonar, radar, a vehicle speed sensor, a yaw-rate sensor, a global positioning system (GPS) receiver, etc. The navigation database 7 is a database that stores map information, road information, and ground object information (information on traffic signs, road markings, facilities, etc.). The eyepoint detection device 8 is configured to include, for example, a camera that shoots a driver's head, and detects a driver's eyepoint (eyes). It is preferable that an alert image ME and a recommended driving image M which are rendered on the head-up display 51 be rendered at locations appropriate to the driver's eyepoint.

As will be described later, the arithmetic processing device 2 identifies one or a plurality of obstacles B present around the vehicle 100, particularly, present close to a traveling direction, by image recognition that uses shot images obtained by the front camera 1. The obstacles B include not only objects fixed on a road, etc. (e.g., traffic signs jutting out over a road, utility poles, and mailboxes), but also moving objects such as pedestrians, bicycles, and parked and stopped vehicles, and objects that are likely to move. When these objects are distinguished from each other, a fixed obstacle B is referred to as static obstacle, and a moving obstacle B (an obstacle B that is likely to move) as dynamic obstacle. When objects are referred to as obstacles B without being particularly distinguished from each other, the objects include static obstacles and dynamic obstacles.

When the arithmetic processing device 2 identifies obstacles B, the arithmetic processing device 2 may be able to improve recognition accuracy by further using information provided from the sensor group 6 such as sonar and radar. In addition, when an obstacle B is a dynamic obstacle and is moving, the arithmetic processing device 2 estimates the moving direction and moving speed of the obstacle B. The arithmetic processing device 2 detects a moving path of the dynamic obstacle using, for example, a publicly known image recognition process such as an optical flow method, based on shot images of the front camera 1, and predicts (estimates) a moving speed and a future moving direction. In addition, when an obstacle B is a dynamic obstacle and is stopped, the arithmetic processing device 2 determines whether the obstacle B is likely to move, and when the obstacle is likely to move, the arithmetic processing device 2 estimates the moving direction and moving speed of the obstacle B.

Note that by using information provided from the sensor group 6 such as a vehicle speed sensor, a yaw-rate sensor, and a GPS receiver, the accuracy of detection of a moving path and a moving speed and the accuracy of estimation of a future moving direction, a moving speed, etc., may be able to be improved. In addition, by obtaining map information, road information, ground object information (information on traffic signs, road markings, facilities, etc.), etc., from the navigation database 7, the accuracy of determination as to whether an obstacle B is a static obstacle or a dynamic obstacle may be able to be improved.

FIG. 3 shows a state in which a bicycle is traveling ahead of the vehicle 100 indicated by solid lines in the same direction as the vehicle 100. Here, the bicycle is a first obstacle B1 which is a dynamic obstacle. The arithmetic processing device 2 detects the first obstacle B1, and calculates the moving direction and moving speed of the first obstacle B1. In a mode exemplified in FIG. 3, the first obstacle B1 is traveling in a moving direction indicated by a dash-dotted line in FIG. 3 at a lower moving speed than that of the vehicle 100. The arithmetic processing device 2 further calculates an estimated moving direction and an estimated moving speed, and calculates influence E exerted on the traveling of the vehicle 100 by the first obstacle B1, based on the estimated moving direction and the estimated moving speed.

The influence E is set, for example, as shown in FIG. 3, as an elliptical region whose long axis matches the moving direction. When the influence E has such an elliptical shape, it is preferable that the obstacle B be located at one focal point of the ellipse or on an outer side in an opposite direction to the estimated moving direction than a focal point. The influence exerted on the traveling of the vehicle 100 by the obstacle B which is a dynamic obstacle is great on a traveling direction side of the obstacle B, and thus, appropriate influence E is set. In addition, it is preferable that the length of the long axis of the ellipse increase, for example, as the estimated moving speed increases. Since the obstacle B moves a long distance for a shorter period of time at a higher estimated moving speed, the influence E is also set so as to increase.

In addition, the influence E is set so as to change in a stepwise manner, and first influence E1 in a region close to the obstacle B is greater influence E than second influence E2 in a region relatively far from the obstacle B. Although here two-level influence E is exemplified, as a matter of course, the influence E may have three or more levels. Note that as will be described later, a change in the influence E is not limited to a stepwise change and may be a continuous change. Note that although here a mode in which the influence E is set for a dynamic obstacle is described, it is preferable that the influence E be also set for a static obstacle. The influence E for a static obstacle can be calculated in the same manner as for a dynamic obstacle when, for example, the vectors of a moving direction and an estimated moving direction are zero and a moving speed is zero. In the present embodiment, as an alert image ME, an image representing the influence E is displayed superimposed on a real view S.

Meanwhile, a future moving direction of a dynamic obstacle is not always the same direction as a detected moving direction. For example, as shown in FIGS. 4 and 5, there may be a case in which a second obstacle B2 which is a different obstacle B than the first obstacle B1 is present further ahead of the first obstacle B1. Note that the second obstacle B2 may be a dynamic obstacle or may be a static obstacle. When the second obstacle B2 influences the traveling of the first obstacle B1, the first obstacle B1 is likely to take action to avoid the second obstacle B2. For example, the first obstacle B1 (bicycle) traveling on an edge of a road in a direction indicated by a block arrow in FIG. 4 is likely to travel close to the center of the road as shown in FIG. 5 (as indicated by a dash-dotted line arrow in FIG. 4) so as to avoid the second obstacle B2 present on the edge of the road. When the first obstacle B1 (bicycle) travels as shown in FIG. 5, an estimated moving direction is not a direction along the road as shown in FIG. 3, but is a direction heading toward the center of the road as shown in FIG. 5.

When the estimated moving direction thus heads toward the center of the road, as shown in FIG. 5, the elliptical influence E also juts out close to the center of the road. When, as shown in FIG. 3, the estimated moving direction of the first obstacle B1 is along the road, even if the vehicle 100 travels a recommended route K (first recommended route K1) which is a traveling route equivalent to a general traveling route of the vehicle 100, the recommended route K does not overlap a region in which the influence E is set. However, when, as shown in FIG. 5, the estimated moving direction of the first obstacle B1 heads toward the center of the road, the first recommended route K1 overlaps a region in which the influence E is set.

Preferably, the arithmetic processing device 2 sets, as a recommended route K, a traveling route with a relatively low likelihood of interference between the obstacle B and the vehicle 100. For example, the recommended route K is set so as to pass through a region with small influence E. When, as shown in FIG. 3, the traveling route does not overlap a region with the influence E set for the first obstacle B1 even if the vehicle 100 travels a general traveling route on the road, a straight-ahead route (first recommended route K1) which is the general traveling route is set as a recommended route K. On the other hand, when, if the vehicle 100 travels the general traveling route (first recommended route K1) on the road, the traveling route is likely to overlap a region with the influence E set for the first obstacle B1 as indicated by dashed lines in FIG. 5, a route (second recommended route K2) that avoids the region in which the influence E is set is set as a recommended route K as indicated by solid lines in FIG. 5.

Namely, the arithmetic processing device 2 sets a range of the influence E in different regions depending on the likelihood of a course of a dynamic obstacle (e.g., the first obstacle B1) changing due to the presence of another obstacle (e.g., the second obstacle B2). Note that an alert image ME is displayed such that a region in which the alert image ME is displayed varies accordingly. In addition, the arithmetic processing device 2 sets a different recommended route K as necessary, based on such influence E. As will be described later, the arithmetic processing device 2 calculates influence E of a dynamic obstacle and a static obstacle, and calculates a recommended route K so as to pass through regions with small influence E, using, for example, a potential method which will be described later.

For example, when it is less likely that a course of a dynamic obstacle (e.g., the first obstacle B1) changes due to the presence of another obstacle (e.g., the second obstacle B2) (e.g., in a case of less than a threshold value for the likelihood of changing the course which is defined in advance), the arithmetic processing device 2 displays an alert image ME as shown in FIG. 3. On the other hand, when it is highly likely that the course of the dynamic obstacle (e.g., the first obstacle B1) changes due to the presence of another obstacle (e.g., the second obstacle B2) (e.g., in a case of greater than or equal to the threshold value for the likelihood of changing the course), the arithmetic processing device 2 displays, as shown in FIG. 4, an alert image ME in a region determined based on an expected changing course, even if the course of the dynamic obstacle (e.g., the first obstacle B1) has not actually changed.

As a matter of course, when the course of the dynamic obstacle (e.g., the first obstacle B1) has actually changed due to the presence of another obstacle (e.g., the second obstacle B2), an alert image ME is displayed as shown in FIG. 5. In addition, by thus setting the range of the influence E in different regions depending on the likelihood of the course of the dynamic obstacle changing due to the presence of another obstacle, even if, for example, the course of the dynamic obstacle (e.g., the first obstacle B1) has suddenly changed due to the presence of another obstacle, an alert image ME appropriate to the changed course of the dynamic obstacle (e.g., the first obstacle B1) is promptly displayed. Note that the threshold value for the likelihood of changing the course may be a fixed value or may be a variable value that changes depending on the conditions around the vehicle 100, the travel speed of the vehicle 100, etc.

As described above, the vehicle driving assistance system 10 is a system that provides the driver with information for assisting in driving, and in the present embodiment, the vehicle driving assistance system 10 provides the driver with information for assisting in driving by displaying an alert image ME and a recommended driving image M superimposed on a real view S. As will be described later with reference to FIGS. 8 to 10, etc., the alert image ME is an image representing a region displayed based on a course of a dynamic obstacle which is one or a plurality of moving obstacles B. The recommended driving image M is an image including a recommended route image MK and a recommended speed image MV. The recommended route image MK is an image representing a recommended route K which is a traveling route with a relatively low likelihood of interference with one or a plurality of obstacles B present in a traveling direction of the vehicle 100. In addition, the recommended speed image MV is an image representing a recommended speed index which is an index related to a travel speed recommended when the vehicle 100 travels the recommended route K.

Note that although FIGS. 8 to 10 exemplify a mode in which an alert image ME and a recommended driving image M are displayed, the vehicle driving assistance system 10 displays at least an alert image ME on the display device 5. That is, a recommended driving image M does not necessarily need to be displayed on the display device 5. By displaying an alert image ME representing influence E exerted by an obstacle B, it becomes possible for the driver to pay attention to the obstacle B and actively perform a driving operation to avoid the obstacle B. As described with reference to FIGS. 3 to 5, the vehicle driving assistance system 10 displays an alert image ME on the display device 5 such that a region in which the alert image ME is displayed varies depending on the likelihood of a course of a dynamic obstacle (e.g., the first obstacle B1) changing due to the presence of another obstacle B (e.g., the second obstacle B2).

As shown in a flowchart of FIG. 6, the vehicle driving assistance system 10 first obtains shot images of views in a traveling direction of the vehicle 100 which are shot by the front camera 1 (#1: a shot image obtaining step and a shot image obtaining function). The vehicle driving assistance system 10 then recognizes images of obstacles B with which the vehicle 100 is likely to interfere, from among the shot images (#2: an obstacle detection step (obstacle recognition step) and an obstacle detection function (obstacle recognition function)). As described above, the obstacles B may be detected not only by image recognition, but also by using other methods that use results of detection by the sensor group 6.

When obstacles B are detected, the vehicle driving assistance system 10 calculates influence E of a dynamic obstacle among the obstacles B, and calculates a recommended route K and a recommended speed index at which the vehicle 100 travels the recommended route K (#4: a recommended route calculation step and a recommended route calculation function). As described above, upon the calculation, it is also preferable that map information, etc., be obtained from the navigation database 7, and a recommended route K and a recommended speed index be calculated taking also into account a road width, whether there is an intersection, etc. FIG. 6 exemplifies a mode in which prior to the recommended route calculation step #4, a database reference step #3 (database reference function) at which information in the navigation database 7 is referred to is performed.

At the recommended route calculation step #4 (recommended route calculation function), a traveling route of the vehicle 100 which is generally assumed (the first recommended route K1 shown in FIGS. 3 to 5) is calculated. In addition, at the recommended route calculation step #4, it is also possible to further calculate a traveling route through which the vehicle 100 passes while avoiding an obstacle B, etc. (e.g., the second recommended route K2 indicated by the solid lines in FIGS. 4 and 5). In the present embodiment, in order to calculate such a recommended route K at the recommended route calculation step #4, the influence exerted on the traveling of the vehicle 100 by the obstacle B is determined. A flowchart of FIG. 7 shows an example thereof.

As shown in FIG. 7, it is determined whether the obstacles B (including a dynamic obstacle and a static obstacle) detected at the obstacle recognition step #1 include a dynamic obstacle (Bd) (#41). If the detected obstacles B include a dynamic obstacle, it is determined whether there is a plurality of detected obstacles B (whether the number Nobs of obstacles B is two or more) (#42). If there is a plurality of obstacles B, it is determined whether another obstacle B (including a dynamic obstacle and a static obstacle) is likely to influence the movement of the dynamic obstacle (#43).

At this time, for example, the likelihood of another obstacle B influencing the movement of the dynamic obstacle is calculated as the “likelihood of changing the course” which is a numerical value. In addition, a direction in which the course of the dynamic obstacle changes is also calculated together with the “likelihood of changing the course”. For the direction in which the course changes, for example, of a plurality of directions that can be calculated based on the behavior of the dynamic obstacle, a direction with the highest likelihood is selected. Then, at step #43, for example, when the calculated likelihood of changing the course is greater than or equal to a threshold value for the likelihood of changing the course, it is determined that another obstacle B is likely to influence the movement of the dynamic obstacle, and an influence flag INFL is set to an enabled state. When the likelihood of changing the course is less than the threshold value for the likelihood of changing the course, it is determined that another obstacle B is unlikely to influence the movement of the dynamic obstacle, and the influence flag INFL is set to a disabled state (maintained in the disabled state).

As another criterion, for example, when, as shown in FIGS. 4 and 5, the traveling route (first recommended route K1) of the vehicle 100 which is generally assumed overlaps the region with the influence E, the influence flag INFL may be set to an enabled state. If it is determined at step #43 that the influence flag INFL is enabled (=True), the setting of a recommended route K and the setting of an image displayed on the display device 5 are performed using a condition of a second mode (mode: B) (#44). For example, as indicated by the solid lines in FIGS. 4 and 5, the second recommended route K2 different than the general recommended route K (first recommended route K1) is set as a recommended route K to avoid the influence of the obstacle B. Alternatively, a recommended speed index that reduces the likelihood of interference between the first obstacle B1 and the vehicle 100 is set, e.g., a recommended travel speed used upon traveling the first recommended route K1 is reduced.

When none of the detected obstacles B influence the traveling of the vehicle 100, the influence flag INFL is in a disabled state. If it is determined at step #43 that the influence flag is disabled (=False), the setting of a recommended route K and the setting of an image displayed on the display device 5 are performed using a condition of a first mode (mode: A) (#45). For example, as shown in FIG. 3, there is no need to avoid the influence of the obstacle B, and the general traveling route (first recommended route K1) is set as a recommended route K. Note that when it is determined at step #41 that the obstacles B do not include a dynamic obstacle (Bd) and it is determined at step #42 that the number Nobs of obstacles B is less than two (one or zero), too, the setting of a recommended route K and the setting of an image displayed on the display device 5 are performed using the condition of the first mode (mode: A).

In the present embodiment, the vehicle driving assistance system 10 displays an alert image ME superimposed on a real view S. The alert image ME is an image representing a region with influence E which is described with reference to FIGS. 3 and 5. The influence E is calculated at the recommended route calculation step #4, and the vehicle driving assistance system 10 performs the recommended route calculation step #4, followed by an image creation step #5 (image creation function) at which an alert image ME is created and an image output step #6 (image output function) at which the alert image ME is outputted to the display device 5.

As described with reference to FIGS. 4 to 7, when the obstacles B include a dynamic obstacle, a course of the dynamic obstacle is likely to vary depending on a relationship with another obstacle B, and a condition for performing the setting of a recommended route K and the setting of an image is selected based on the likelihood. The vehicle driving assistance system 10 displays an alert image ME on the display device 5 such that a region in which the alert image ME is displayed varies depending on the likelihood of a course of a dynamic obstacle changing due to the presence of an obstacle B different than the dynamic obstacle.

At the image output step #6, for example, using also a result of detection by the eyepoint detection device 8, etc., the alert image ME is outputted so as to be displayed appropriate to the location of the obstacle B in the real view S. As a matter of course, when an alert image ME is created at the image creation step #5, an alert image ME may be created appropriate to the location of the obstacle B in the real view S, taking into account a driver's eyepoint. In addition, an alert image ME may be created and displayed in accordance with a display mode of the monitor 52.

As described above, in the present embodiment, the vehicle driving assistance system 10 calculates also a recommended route K and a recommended speed index at the recommended route calculation step #4, creates also a recommended driving image M including a recommended route image MK and a recommended speed image MV at the image creation step #5, and outputs also those images to the display device 5 at the image output step #6. As will be described later with reference to FIG. 8, etc., the recommended route image MK and the recommended speed image MV are associated with each other.

It can be said that the vehicle driving assistance method is a method for implementing driving assistance by performing each step such as those described above, using hardware and software that form the vehicle driving assistance system 10. In addition, a computer (e.g., the arithmetic processing unit 4 which will be described later with reference to FIG. 2) included in the vehicle driving assistance system 10 executes a program that implements each function such as those described above.

FIGS. 8 to 10 show an example of an alert image ME and a recommended driving image M which are superimposed on a real view S. The alert image ME and the recommended driving image M are displayed appropriate to the location of an obstacle B in the real view S, and prompt the driver to recognize the presence of the obstacle B and the likelihood of the obstacle B influencing driving, enabling to appropriately provide guidance on how the driver should drive the vehicle 100 in relation to the obstacle B.

FIG. 8 exemplifies the display device 5 that superimposes an alert image ME and a recommended driving image M on a real view S when the vehicle 100 is present at a location indicated by the solid lines in FIG. 3. The vehicle driving assistance system 10 has detected that obstacles B are present in portions enclosed by dashed lines in FIG. 8. Here, three obstacles B including a first obstacle B1, a third obstacle B3, and a fourth obstacle B4 are detected and are all dynamic obstacles. The first obstacle B1 is a person riding on a bicycle, and the third obstacle B3 and the fourth obstacle B4 are pedestrians. The third obstacle B3 is a standing pedestrian or a pedestrian walking slowly, e.g., taking a walk. The fourth obstacle B4 is a pedestrian walking with quick steps or running.

In a mode exemplified in FIG. 8, the vehicle driving assistance system 10 displays an alert image ME for the first obstacle B1, based on influence E for the first obstacle B1 closest to the vehicle 100. That is, the alert image ME is an image representing a region in which a dynamic obstacle and the vehicle 100 are likely to interfere with each other. Although here one obstacle B is a target, an alert image ME may be displayed for a plurality of obstacles B (a mode for a plurality of obstacles B will be described later with reference to FIG. 14.). For example, it is preferable to display an alert image ME for an obstacle B present within a predefined range from the vehicle 100, or for an obstacle B that approaches a recommended route K of the vehicle 100 at a predefined speed or more.

To accommodate the influence E which is set in a stepwise manner, the alert image ME is displayed in a display mode in which the influence E exerted on the traveling of the vehicle 100 by a dynamic obstacle is shown in a stepwise manner. Here, a first alert image ME1 corresponding to first influence E1 and a second alert image ME2 corresponding to second influence E2 are displayed. It is preferable, for example, that the first alert image ME1 closer to the first obstacle B1 be displayed in white or yellow, and the second alert image ME2 be displayed in orange or red. It is preferable that the colors of the first alert image ME1 and the second alert image ME2 be colors that call more attention for a shorter distance between the vehicle 100 and the obstacle B, taking also into account a relative speed to the vehicle 100, etc., based on cognitive engineering, etc. Compared to the white or yellow used for the first alert image ME1, the orange or red used for the second alert image ME2 generally reminds the driver of the necessity for attention.

The bicycle which is the first obstacle B1 is traveling straight ahead at this point in time, but may suddenly change its course to a roadway side or may fall over. By thus displaying the alert image ME for the first obstacle Bl, the driver recognizes the presence of the first obstacle B1 and can perform a driving operation, paying attention to the movement of the first obstacle B1.

It is possible to assist in a driver's driving operation by thus displaying an alert image ME, but in the present embodiment, the vehicle driving assistance system 10 further displays a recommended route image MK and a recommended speed image MV which are superimposed on the real view S, in addition to the alert image ME. As described above with reference to FIGS. 3 to 5, the vehicle driving assistance system 10 sets a recommended route K so as to avoid a region in which the obstacle B is estimated to influence the traveling of the vehicle 100 (a region in which influence E is set) as much as possible. That is, a traveling route with a relatively low likelihood of interference between an obstacle B present in a traveling direction of the vehicle 100 and the vehicle 100 is set as a recommended route K.

When the first obstacle B1 travels straight ahead, as indicated by the solid lines in FIG. 3, a generally recommended traveling route (first recommended route K1) can be set as a recommended route K. FIG. 8 exemplifies a mode in which a recommended route image MK which corresponds to the recommended route K is displayed so as to show a route going straight ahead on a road. The recommended route image MK is displayed so as to be associated with a recommended speed image MV. In the present embodiment, the recommended speed image MV is displayed in a display region of the recommended route image MK, and is displayed as a recommended driving image M in which the recommended speed image MV is integrated with the recommended route image MK.

The recommended driving image M (recommended route image MK) is formed by arranging a plurality of unit images UM along the recommended route K. For example, the recommended speed image MV can be represented by making the colors of the unit images UM arranged side by side along the recommended route K different from each other. In the mode exemplified in FIG. 8, since a region in which the influence E is set does not overlap the recommended route K, there is no need to prompt the driver to control speed, e.g., slow down. Hence, all unit images UM are displayed using first unit images M1 (e.g., white or blue) that allow to travel at a general speed.

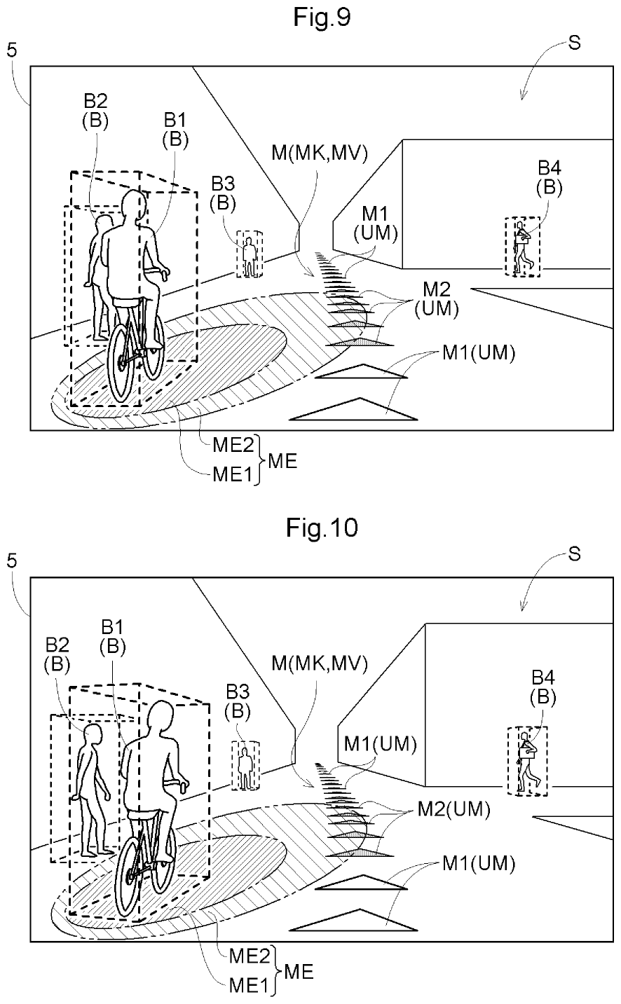

FIG. 9 exemplifies the display device 5 that superimposes an alert image ME and a recommended driving image M on a real view S when the vehicle 100 is present at a location indicated by the solid lines in FIG. 4. The vehicle driving assistance system 10 has detected that obstacles B are present in portions enclosed by dashed lines in FIG. 9. Here, four obstacles B further including a second obstacle B2 which is a pedestrian are detected and are all dynamic obstacles.

As described above with reference to FIGS. 4 and 5, a bicycle which is the first obstacle B1 is likely to change its course toward the center of the road in order to pass through while avoiding the second obstacle B2 which is a pedestrian. Hence, as shown in FIG. 4, even if the bicycle which is the first obstacle B1 is traveling straight ahead without changing its course, an estimated moving direction of the first obstacle B1 deviates toward the center of the road, and the region with the influence E is also set so as to jut out toward the center of the road in the estimated moving direction. The vehicle driving assistance system 10 displays an alert image ME for the first obstacle B1, based on the influence E for the first obstacle B1. That is, compared to the alert image ME exemplified in FIG. 8, the alert image ME exemplified in FIG. 9 is displayed so as to jut out toward the center of the road. By displaying such an alert image ME, the driver recognizes the presence of the first obstacle B1 and recognizes the likelihood of the first obstacle B1 coming over to a location where the first obstacle B1 influences the traveling of the vehicle 100, and can perform a driving operation, paying attention to the movement of the first obstacle B1.

Note that as a matter of course, as described above with reference to FIG. 5, when the bicycle which is the first obstacle B1 has actually changed its course, too, an estimated moving direction of the first obstacle B1 deviates toward the center of the road, and the region with the influence E is also set so as to jut out toward the center of the road in the estimated moving direction. FIG. 10 exemplifies the display device 5 that superimposes an alert image ME and a recommended driving image M on a real view S when the vehicle 100 is present at a location indicated by the solid lines in FIG. 5. The vehicle driving assistance system 10 has detected that obstacles B are present in portions enclosed by dashed lines in FIG. 10. Here, too, four obstacles B are detected and are all dynamic obstacles.

FIGS. 9 and 10 also exemplify a mode in which in addition to the alert image ME, a recommended route image MK and a recommended speed image MV are further displayed superimposed on the real view S. As described above with reference to FIGS. 4 and 5, the vehicle driving assistance system 10 sets a recommended route K so as to avoid a region in which the obstacle B is estimated to influence the traveling of the vehicle 100 (a region in which the influence E is set) as much as possible. FIGS. 4 and 5 exemplify a mode in which a second recommended route K2 that significantly detours around the first obstacle B1 is set, to describe a concept of driving assistance. However, depending on the width of a road through which the vehicle 100 passes, etc., a route that thus detours around the obstacle B may not be able to be set. FIGS. 9 and 10 exemplify a recommended route image MK and a recommended speed image MV for when the second recommended route K2 that thus detours around the first obstacle B1 cannot be set and the first recommended route K1 is set as a recommended route K.

As with the mode exemplified in FIG. 8, in the FIGS. 9 and 10, too, the recommended driving image M (recommended route image MK) is formed by arranging a plurality of unit images UM along the recommended route K. In both the mode exemplified in FIG. 8 and the mode exemplified in FIGS. 9 and 10, the recommended route K is the first recommended route K1, and thus, the arrangement of the unit images UM is the same between FIGS. 8, 9, and 10. Note, however, that the recommended speed (recommended speed index) has changed with a change in the estimated moving direction of the first obstacle B 1. For example, the recommended speed image MV can be represented by making the colors of the unit images UM arranged side by side along the recommended route K different from each other. In the mode exemplified in FIGS. 9 and 10, since the region in which the influence E is set overlaps the recommended route K, it is desirable to prompt the driver to, for example, decelerate or slow down. Hence, the recommended speed of the vehicle 100 decreases in the traveling direction.

FIGS. 9 and 10 exemplify a mode in which unit images UM arranged in a region in which the vehicle 100 is located more rearward than the first obstacle B1 are displayed using first unit images M1 (e.g., white or blue), and unit images UM arranged in a region in which the vehicle 100 is positioned next to the first obstacle B1 (a region in which the alert image ME overlaps the recommended driving image M) are displayed using second unit images M2 (e.g., yellow). In addition, unit images UM arranged in a region in which the vehicle 100 passes the first obstacle B1 and is located more forward than the first obstacle B1 are displayed using first unit images M1 (e.g., white or blue).

As with the colors of the alert image ME, it is preferable that the colors of the first unit image M1 and the second unit image M2 be colors that call more attention for a lower recommended speed, based on cognitive engineering, etc. Compared to the white or blue used for the first unit image M1, the yellow used for the second unit image M2 generally reminds a person of the necessity for more attention. In addition, the recommended speed image MV is displayed so as to be associated with the recommended route image MK by displaying recommended speed indices at respective points on the recommended route K. For example, a travel speed recommended for the vehicle 100 varies from point to point on the recommended route K. By displaying recommended speed indices at the respective points on the recommended route K such that the recommended speed indices are associated with the recommended route image MK, the driver can be informed about information on what travel speed is appropriate to travel the recommended route K, in an easy-to-understand manner.

As described above with reference to FIGS. 3 to 10, in the vehicle driving assistance system 10 of the present embodiment, a region in which an alert image ME is displayed varies between when it is unlikely that a course of a dynamic obstacle changes due to the presence of another obstacle B and when it is likely that the course of the dynamic obstacle changes due to the presence of another obstacle B. Specifically, as is clear from a comparison of FIGS. 3 and 4 and a comparison of FIGS. 8 and 9, when a course (estimated moving direction) of a dynamic obstacle is likely to change due to the presence of an obstacle B different than the dynamic obstacle, an alert image ME is displayed in a region determined based on the changed course.

Meanwhile, the alert image ME is an image for prompting the driver to pay attention, and thus, does not need to be set in a region in which a dynamic obstacle cannot travel. For example, when, as exemplified in FIG. 11, a region through which a detected obstacle B such as a pedestrian or a bicycle passes can be separated from a region through which the vehicle 100 passes by a guardrail G, a hedge, etc., a portion of an alert image ME in an unnecessary area may be excluded. That is, it is preferable that the alert image ME be displayed excluding a region in which a dynamic obstacle is unlikely to interfere with a traveling route of the vehicle 100, based on a structure of a road on which the vehicle 100 and the dynamic obstacle travel.

Such a structure of a road can be identified, for example, by image recognition based on shot images obtained by the front camera 1. Furthermore, the guardrail G, a hedge, etc., may be identified based on map information, road information, and ground object information (information on traffic signs, road markings, facilities, etc.) which are obtained from the navigation database 7. In addition, based on results of detection by the sensor group 6 such as sonar and radar that detect objects on the sides of the vehicle 100, image recognition may be assisted, or the guardrail G, a hedge, etc., may be identified.

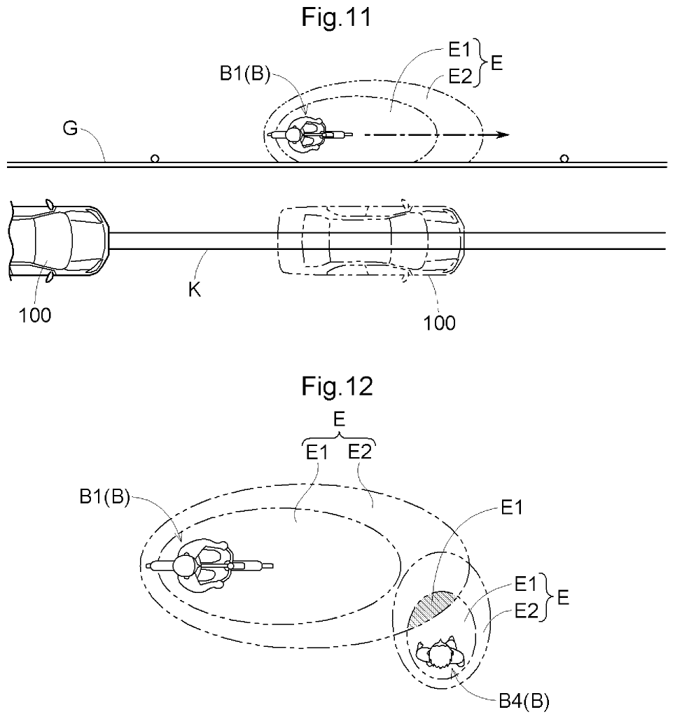

Although in the above description a mode in which only an alert image ME for a single dynamic obstacle is displayed is exemplified and described, as a matter of course, alert images ME for a plurality of dynamic obstacles may be displayed. When there is a plurality of dynamic obstacles and alert images ME are displayed for the respective dynamic obstacles, there may be an overlapping region in which the plurality of alert images ME overlap each other. FIG. 12 exemplifies influence E which forms the basis for alert images ME for when the first obstacle B1 (bicycle) and the fourth obstacle B4 (pedestrian) come close to each other, with their estimated moving directions intersecting each other. As shown in FIG. 12, it is preferable that when a region with influence E for the first obstacle B1 overlaps a region with influence E for the fourth obstacle B4, an overlapping region be set as a region determined based on a great influence E side. Therefore, it is preferable that each of the alert images ME displayed for the influence E also be displayed such that the influence E of an alert image ME with the greatest influence E in the overlapping region be set as the influence E of the overlapping region.

Meanwhile, the recommended route K is set so as to pass through a region with small influence E. The influence E can be calculated as a cost related to traveling in a range in which the vehicle 100 can travel (e.g., on a road). For example, the cost is high for a location where an obstacle B is present and an area around the obstacle B (e.g., a region with first influence E1), and the cost is low for a location where there are no obstacles B, etc., and thus the vehicle 100 can travel smoothly. In addition, the cost of a destination on a traveling route in a range of shot images is set to the lowest value (e.g., zero).

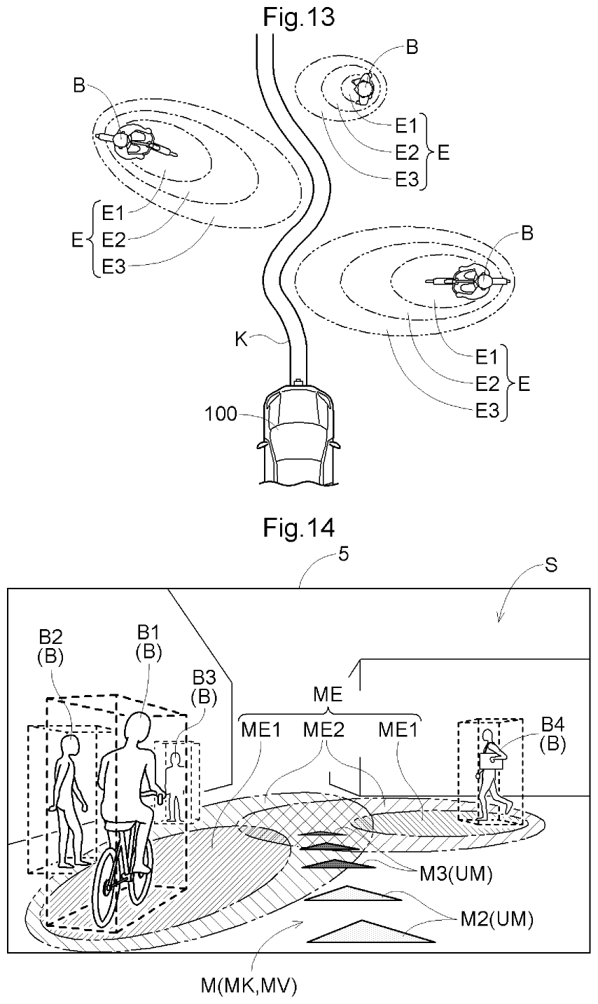

The vehicle driving assistance system 10 can calculate a recommended route K by calculating the shortest course that passes through low-cost points from a current location to a destination. If a course that passes through lowest-cost points is simply set, then a distance may become long. Therefore, a recommended route K is calculated taking also into account vehicle speed (required time), etc. In this calculation method, a route in a direction with a low cost is calculated, and thus, a calculation load becomes comparatively light. Note that there is also a case in which there are a large number of obstacles B and thus it is better for the vehicle 100 to stop. To handle such a case, it is preferable that an upper limit of a cost at which a route can be shut down be also set. FIG. 13 exemplifies a state in which a plurality of regions with influence E are set for a plurality of obstacles B. The vehicle driving assistance system 10 calculates a recommended route K by calculating the shortest course that passes through low-cost points, based on the influence E. A recommended route image MK is displayed so as to pass through regions with small influence E.

Although description is simply made above, for a technique for thus performing autonomous operation while avoiding obstacles B in a three-dimensional space, there is known, for example, a potential method. The potential method is publicly known and thus a detailed description thereof is omitted, but, for example, by defining potential functions for a current location, a target location (destination), and a location where an obstacle B is present, and setting a gradient of the potential functions as a traveling direction, a recommended route K can be calculated. Note that the gradient can be found by a partial derivative for each coordinate component (e.g., for each of x-, y-, and z-axes in a three-dimensional Cartesian coordinate system.). A potential gradient to the destination acts in an attractive direction, and a traveling direction of the recommended route K goes toward the destination. On the other hand, a potential gradient of the obstacle B acts in a repulsive direction, and the recommended route K is set so as to avoid the obstacle B. The potential functions can be updated in real time based on observation information (shot images, results of detection by the sensor group 6, etc.), by which an appropriate recommended route K at each point in time can be calculated.

When a potential function is defined for an obstacle B, influence E can be set based on a potential gradient. Although a mode in which influence E is set in a stepwise manner is exemplified with reference to FIGS. 3 to 5, etc., a mode in which influence E changes continuously may be adopted. In addition, for example, by setting a threshold value for a parameter such as a potential gradient that changes continuously, influence E may be represented in a stepwise manner. The same also applies to an alert image ME created based on influence E, and FIGS. 8 to 10, etc., exemplify a mode in which influence E is displayed in colors that vary in a stepwise manner. However, the colors may be changed continuously. In addition, by setting a threshold value for influence E that changes continuously, an alert image ME may be represented in a stepwise manner.

FIG. 14 shows the display device 5 that superimposes alert images ME on a real view S when the first obstacle B1 (bicycle) and the fourth obstacle B4 (pedestrian) come close to each other, with their estimated moving directions intersecting each other, as exemplified in FIG. 12. In a region in which a second alert image ME2 for the first obstacle B1 overlaps a first alert image ME1 for the fourth obstacle B4, the first alert image ME1 corresponding to relatively great first influence E1 is displayed.

FIG. 14 shows a mode in which a recommended driving image M is also superimposed, as with FIGS. 8 to 10. As shown in FIG. 14, an area ahead of the vehicle 100, i.e., a traveling route, is blocked by the alert images ME. That is, the traveling route of the vehicle 100 is blocked by regions in which influence E is set. Hence, for example, the recommended speed is set to be lower by one level than normal, and the recommended driving image M is displayed using second unit images M2 (e.g., yellow) representing slowing down even in a region in which the recommended driving image M does not overlap the alert images ME. In addition, in a region in which the recommended driving image M overlaps the alert images ME (second alert images ME2), the recommended driving image M is displayed using third unit images (e.g., red) so as to prompt the driver to go at the slowest possible speed or to stop. Furthermore, in FIG. 14, the recommended driving image M discontinues at a location where two first alert images ME1 come close to each other. By this, the driver is informed, for example, that it is desirable to reduce the speed of the vehicle 100 to a speed close to “stop” in order to pay attention to both the first obstacle B1 and the fourth obstacle B4 that approach the vehicle 100 in different directions.

### Other Embodiments

Other embodiments will be described below. Note that a configuration of each embodiment described below is not limited to being applied alone, and can also be applied in combination with a configuration of another embodiment as long as a contradiction does not arise.

(1) The above description exemplifies a mode in which when a course of a dynamic obstacle is likely to change due to the presence of another obstacle B, an alert image ME is displayed in a region determined based on the changing course. However, an alert image ME does not need to be displayed based on the changing course as long as a region in which the alert image ME is displayed varies depending on the likelihood of the course of the dynamic obstacle changing due to the presence of another obstacle B.

For example, a mode may be adopted in which when there is almost no likelihood of the course of the dynamic obstacle changing due to the presence of another obstacle B (e.g., in a case of less than the threshold value for the likelihood of changing the course), an alert image ME is not displayed, and when there is a likelihood of the course of the dynamic obstacle changing due to the presence of another obstacle B (e.g., in a case of greater than or equal to the threshold value for the likelihood of changing the course), an alert image ME is displayed. In addition, a mode may be adopted in which when there is almost no likelihood of the course of the dynamic obstacle changing due to the presence of another obstacle B (e.g., in a case of less than the threshold value for the likelihood of changing the course), only a first alert image ME1 is displayed, and when there is a likelihood of the course of the dynamic obstacle changing due to the presence of another obstacle B (e.g., in a case of greater than or equal to the threshold value for the likelihood of changing the course), a second alert image ME2 is further displayed in addition to the first alert image ME1. Note that the second alert image ME2 may be an image corresponding to second influence E2 determined based on an estimated moving direction for when there is almost no likelihood of the course of the dynamic obstacle changing due to the presence of another obstacle B. By extending a region in which an alert image ME is displayed, the driver can be informed about the necessity of more attention.

(2) Note that in the mode, too, in which when there is a likelihood of the course of the dynamic obstacle changing due to the presence of another obstacle B (e.g., in a case of greater than or equal to the threshold value for the likelihood of changing the course), an alert image ME is displayed in a region determined based on the changing course, display may be performed as shown in other embodiments (1). That is, when there is almost no likelihood of changing the course (e.g., in a case of less than the threshold value for the likelihood of changing the course), the vehicle driving assistance system 10 may not display an alert image ME, and when there is a likelihood of changing the course (e.g., in a case of greater than or equal to the threshold value for the likelihood of changing the course), the vehicle driving assistance system 10 may display an alert image ME in a region determined based on the changing course. In addition, when there is almost no likelihood of changing the course (e.g., in a case of less than the threshold value for the likelihood of changing the course), the vehicle driving assistance system 10 may display only a first alert image ME2, and when there is a likelihood of changing the course (e.g., in a case of greater than or equal to the threshold value for the likelihood of changing the course), the vehicle driving assistance system 10 may display a first alert image ME1 and a second alert image ME2 in a region determined based on the changing course.

(3) The above description exemplifies a mode in which a recommended route image MK is displayed by arranging unit images UM along a recommended route K, with reference to FIGS. 8 to 10 and 14, etc. However, a recommended route image MK may be formed in a continuous linear form.

(4) The above description exemplifies a mode in which differences in recommended speed index are represented by making colors different from each other, with reference to FIGS. 9, 10, and 14, etc. Even in the mode in which a recommended route image MK includes a plurality of unit images UM or the mode in which, as described in other embodiments (3), a recommended route image MK is formed in a continuous linear form, a mode can be adopted in which a recommended speed image MV is displayed in a manner in which at least one of the color, shape, and movement of a recommended driving image M varies depending on a recommended speed index such as a travel speed.

(4-1) The above description exemplifies a mode in which color gradation is represented by arranging unit images UM with different colors along a recommended route K, with reference to FIGS. 9, 10, and 14, etc. However, a mode may be adopted in which, for example, a recommended route image MK is formed in a continuous linear form, and the color changes in a single continuous image.

(4-2) In addition, when a recommended route image MK includes a plurality of unit images UM, a recommended speed image MV may be represented by making arrangement modes of the plurality of unit images UM different from each other. By making spacings at which the plurality of unit images UM are arranged vary depending on a recommended speed index such as a travel speed, a recommended speed image MV represented by making the arrangement modes different from each other can be realized. Considering the spacings between the unit images UM as distances at which the vehicle 100 travels in a unit of time, when the spacings are relatively short, the travel speed of the vehicle 100 is low, enabling to prompt the driver to drive slowly.

(4-3) In addition, a recommended speed image MV may be displayed in a manner in which the movement of the recommended speed image MV varies depending on a recommended speed index such as the travel speed of the vehicle 100. For example, a recommended speed image MV may be represented by making a moving speed at which a unit image UM moves in a traveling direction along a recommended route K vary depending on a recommended speed index such as a travel speed. Considering the moving speed of a unit image UM as the travel speed of the vehicle 100, when the moving speed V is relatively slow, the travel speed of the vehicle 100 is low, enabling to prompt the driver to drive slowly.

Note that when a recommended speed image MV is displayed in a manner in which the movement of the recommended speed image MV varies depending on a recommended speed index such as the travel speed of the vehicle 100, too, a recommended route image MK may be formed in a continuous linear form. For example, a single recommended route image MK may move along a recommended route K, or a continuous linear recommended route image MK may be in a sweep mode (a mode in which the recommended route image MK disappears in turn from the front side and when it reaches an end of the recommended route K, rendering is performed again, which is repeated).

(4-4) When a recommended route image MK is displayed in an arrangement of unit images UM, a recommended speed image MV may be displayed such that the shapes of the respective unit images UM vary depending on a recommended speed index such as a travel speed. For example, each unit image UM is formed in a pentagon shape whose top edge portion has an arrow shape going along a recommended route K. Each unit image UM is formed such that the angle (interior angle) of the top edge portion going in a traveling direction increases as the travel speed decreases. For example, a unit image UM whose top edge portion has the largest angle has a linear top edge portion. That is, a unit image UM having the slowest speed (e.g., zero) is formed in a rectangular shape with no arrow portion. By this unit image UM, for example, an image that recommends stopping the vehicle 100 can be represented.

Note that when a single recommended route image MK is formed in a continuous linear form, the shape of the single recommended route image MK may be changed. For example, by forming a top end portion of a single continuous linear recommended route image MK in an arrow-like pointed shape and making the shape of the top end portion vary, a travel speed, etc., may be represented. In this case, it is preferable that when the recommended travel speed is high, the top end portion be pointed, and the angle of the top end portion increase (sharpness decrease and the top end portion become flattened) as the recommended travel speed decreases.

(5) The above description exemplifies a mode in which a travel speed index represented by a recommended speed image MV is a travel speed (absolute speed) recommended for the vehicle 100. That is, a mode is exemplified in which a recommended speed image MV is displayed in a display mode in which the recommended speed image MV corresponds to the absolute speed of the vehicle 100. However, the travel speed index is not limited to the absolute speed as long as the travel speed index is an index related to a travel speed recommended when the vehicle 100 travels a recommended route K. For example, the travel speed index may be the acceleration of the vehicle 100 including deceleration and acceleration recommended for the vehicle 100 and increased speed acceleration allowed for the vehicle 100. Therefore, a recommended speed image MV may be displayed in a display mode in which the recommended speed image MV corresponds to the acceleration of the vehicle 100 including deceleration and acceleration recommended for the vehicle 100 and increased speed acceleration allowed for the vehicle 100.

(6) Although in the above description a mode in which a recommended speed image MV is displayed in a display region of a recommended route image MK is exemplified and described, it does not hinder a mode in which the recommended speed image MV is displayed in a region other than the display region of the recommended route image MK, as long as the recommended route image MK and the recommended speed image MV are displayed so as to be associated with each other. For example, a mode may be adopted in which a recommended speed image MV representing a recommended speed in numerical values is placed next to a continuous arrow-shaped recommended route image MK. The recommended speed image MV placed next to the recommended route image MK is not limited to numerical values and may be any as long as a recommended speed index can be represented by color, shape, or movement. For example, the recommended speed index may be represented by color gradation of side lines going along a recommended route image MK, movement of the side lines, etc.

### Overview of the Embodiments

An overview of a vehicle driving assistance system (10), a vehicle driving assistance method, and a vehicle driving assistance program described above will be briefly described below.

The vehicle driving assistance system (10) includes

a display part (5) that displays an alert image (ME) superimposed on a real view (S),

the alert image (ME) is an image having a region indicating the call for attention based on a course of a dynamic obstacle (B), the dynamic obstacle (B) being one or a plurality of moving obstacles (B), and

the region indicating a call for attention varies depending on a likelihood of the course of the dynamic obstacle (B) changing due to presence of another obstacle (B).

By displaying an alert image (ME), the driver can be appropriately informed about the presence of a dynamic obstacle (B). In addition, by displaying the alert image (ME) in a different region based on whether a course of the dynamic obstacle (B) changes due to another obstacle (B), the driver can be informed that the course of the dynamic obstacle (B) is likely to change. By this, the driver can perform a driving operation, paying more attention to the dynamic obstacle (B). As such, according to this configuration, taking also into account a correlation between a plurality of obstacles (B) around the vehicle (100), the driver can be appropriately informed about information for traveling while avoiding moving obstacles (B).

Here, it is preferable that the alert image (ME) represent a region in which the dynamic obstacle (B) and a vehicle (100) are likely to interfere with each other.

By thus displaying an alert image (ME), the driver can easily recognize the presence of a dynamic obstacle (B) and the presence of a region in which the traveling of the vehicle (100) is influenced by movement of the dynamic obstacle (B).

In addition, it is preferable that when the alert image (ME) is displayed in a region different than a region in which the alert image (ME) is displayed when the course of the dynamic obstacle (B) does not change, based on a likelihood of the course of the dynamic obstacle (B) changing due to presence of another obstacle (B), the alert image (ME) be displayed in a region determined based on the changing course.

The dynamic obstacle (B) is a moving obstacle (B), and a moving direction of the dynamic obstacle (B) is also likely to change. Even if the driver recognizes the presence of the dynamic obstacle (B), when the moving direction of the dynamic obstacle (B) is suddenly changed without a driver's expectation, it may surprise the driver. However, when the course of the dynamic obstacle (B) is likely to change, by displaying an alert image (ME) based on the changing course, the driver can also expect the likelihood of the dynamic obstacle (B) changing its course, increasing the possibility that the driver can calmly and promptly react.

Note that it is preferable that the alert image (ME) be displayed excluding a region in which the dynamic obstacle (B) is unlikely to interfere with a traveling route of a vehicle (100), based on a structure of a road on which the vehicle (100) and the dynamic obstacle (B) travel.

An alert image (ME) is also useful in terms of allowing the driver to recognize the presence of an obstacle (B). However, on a traveling route of the vehicle (100), if an alert image (ME) is displayed even in a region in which the vehicle (100) and a dynamic obstacle (B) are unlikely to interfere with each other, the driver may feel annoyed. Therefore, it is preferable that an alert image (ME) be displayed excluding a region in which a dynamic obstacle (B) is unlikely to interfere with a traveling route of the vehicle (100).

In addition, it is preferable that the alert image (ME) be displayed in a manner in which the alert image (ME) shows influence (E) in a stepwise manner, the influence (E) being exerted on traveling of a vehicle (100) by the dynamic obstacle (B).

By displaying an alert image (ME) based on the level of influence (E), the driver can easily recognize the influence (E), and it becomes easier for the driver to perform a driving operation taking into account the influence (E).

In addition, it is preferable that the display part (5) further display a recommended route image (MK) superimposed on the real view (S), the recommended route image (MK) representing a recommended route (K), the recommended route (K) being a traveling route with a relatively low likelihood of interference with at least the dynamic obstacle (B), and the recommended route image (MK) be displayed so as to pass through a region with small influence (E) among a plurality of levels of the influence (E).

By displaying a recommended route image (MK), the driver can be appropriately informed about information on what route is appropriate to travel, in an easy-to-understand manner. Since the recommended route image (MK) informs about a recommended route (K) which is set so as to pass through a region with small influence (E), the driver can be informed about appropriate driving information with reduced influence of an obstacle B.

In addition, it is preferable that when there is a plurality of the dynamic obstacles (B), the alert image (ME) is displayed for each of the dynamic obstacles (B), and there is an overlapping region in which the plurality of alert images (ME) overlap each other, each of the alert images (ME) be displayed such that the influence (E) of the alert image (ME) with greatest influence (E) in the overlapping region be set as the influence (E) of the overlapping region.

In an overlapping region in which the plurality of alert images (ME) overlap each other, instead of obstacles (B) for the respective alert images (ME) influencing averagely, an obstacle (B) on a greater influence (E) side is more likely to influence the traveling of the vehicle (100). Therefore, by displaying an alert image (ME) based on the influence (E) of an obstacle (B) with a greater influence (E) side, the driver can be informed about appropriate driving information.

Various technical features of the above-described vehicle driving assistance system (10) are also applicable to a vehicle driving assistance method and a vehicle driving assistance program. For example, the vehicle driving assistance method can have steps including features of the above-described vehicle driving assistance system (10). In addition, the vehicle driving assistance program can cause a computer to implement functions including the features of the above-described vehicle driving assistance system (10). As a matter of course, these vehicle driving assistance method and vehicle driving assistance program can also provide the functions and effects of the above-described vehicle driving assistance system (10). Furthermore, various additional features exemplified as preferred modes of the vehicle driving assistance system (10) can also be incorporated into these vehicle driving assistance method and vehicle driving assistance program, and the method and the program can also provide functions and effects corresponding to their additional features.

The vehicle driving assistance method in that case is

a vehicle driving assistance method for displaying, on a display part (5), an alert image (ME) superimposed on a real view (S),

the alert image (ME) is an image having a region indicating a call for attention based on a course of a dynamic obstacle (B), the dynamic obstacle (B) being one or a plurality of moving obstacles (B), and

the vehicle driving assistance method includes a step of displaying the region indicating the call for attention such that the region varies depending on a likelihood of the course of the dynamic obstacle (B) changing due to presence of another obstacle (B).

In addition, the vehicle driving assistance program is

a vehicle driving assistance program for displaying, on a display part (5), an alert image (ME) superimposed on a real view (S),

the alert image (ME) is an image having a region indicating a call for attention based on a course of a dynamic obstacle (B), the dynamic obstacle (B) being one or a plurality of moving obstacles (B), and

the vehicle driving assistance program causes a computer to implement a function of displaying the region indicating a call for attention such that the region varies depending on a likelihood of the course of the dynamic obstacle (B) changing due to presence of another obstacle (B).

1. A vehicle driving assistance system comprising:
a processor programmed to:
display an alert image superimposed on a real view on a display,
the alert image being an image having a region indicating a call for attention based on a course of a dynamic obstacle, the dynamic obstacle being one or a plurality of moving obstacles, and
the region indicating the call for attention varying depending on a likelihood of the course of the dynamic obstacle changing due to presence of another obstacle.

2. The vehicle driving assistance system according to claim 1, wherein the alert image represents a region in which the dynamic obstacle and a vehicle are likely to interfere with each other.

3. The vehicle driving assistance system according to claim 1, wherein, when the alert image is displayed in a region different than a region in which the alert image is displayed when the course of the dynamic obstacle does not change, based on a likelihood of the course of the dynamic obstacle changing due to presence of the other obstacle, the alert image is displayed in a region determined based on the changing course.

4. The vehicle driving assistance system according to claim 1, wherein the alert image is displayed excluding a region in which the dynamic obstacle is unlikely to interfere with a traveling route of a vehicle, based on a structure of a road on which the vehicle and the dynamic obstacle travel.

5. The vehicle driving assistance system according to claim 1, wherein the alert image is displayed in a manner in which the alert image shows influence in a stepwise manner, the influence being exerted on traveling of a vehicle by the dynamic obstacle.

6. The vehicle driving assistance system according to claim 5, wherein:
the processor is programmed to display a recommended route image superimposed on the real view on the display, the recommended route image representing a recommended route, the recommended route being a traveling route with a relatively low likelihood of interference with at least the dynamic obstacle, and
the recommended route image is displayed so as to pass through a region with small influence among a plurality of levels of the influence.

7. The vehicle driving assistance system according to claim 6, wherein, when there is a plurality of the dynamic obstacles, the alert image is displayed for each of the dynamic obstacles, and there is an overlapping region in which the plurality of alert images overlap each other, each of the alert images is displayed such that the influence of the alert image with greatest influence in the overlapping region is set as the influence of the overlapping region.

8. A vehicle driving assistance method, comprising:
displaying, on a display, an alert image superimposed on a real view,
the alert image being an image having a region indicating a call for attention based on a course of a dynamic obstacle, the dynamic obstacle being one or a plurality of moving obstacles; and
displaying the region indicating a call for attention such that the region varies depending on a likelihood of the course of the dynamic obstacle changing due to presence of another obstacle.

9. A computer-readable storage medium storing a computer-executable vehicle driving assistance program, that cause a computer to execute functions, comprising:
displaying, on a display part, an alert image superimposed on a real view,
the alert image being an image having a region indicating a call for attention based on a course of a dynamic obstacle, the dynamic obstacle being one or a plurality of moving obstacles; and
displaying the region indicating the call for attention such that the region varies depending on a likelihood of the course of the dynamic obstacle changing due to presence of another obstacle.
